(19) United States
(12) Patent Application Publication
(10) Pub. No.: US 2026/0030640 A1
(43) Pub. Date: Jan. 29, 2026

(54) Authenticating Items Using a Learning Model

(71) Applicant: eBay Inc., San Jose, CA (US)

(72) Inventors: Fang Fang, Scarsdale, NY (US); Saif Mohamed Kantrikar, San Ramon, CA (US); Tomasz Piotr Skrzypczyk, Lodz (PL); Rafal Jan Topolnicki, Wroclaw (PL); Maciej Twardowski, Warsaw (PL); Christopher Michael Matthews, Pacifica, CA (US); Ali Shahrokni, San Jose, CA (US); Chitradurga Vijayendra Raghavendra Rao, Austin, TX (US)

(73) Assignee: eBay Inc., San Jose, CA (US)

(21) Appl. No.: 18/788,023

(22) Filed: Jul. 29, 2024

(51) Int. Cl. G06Q 30/018; G06T 7/11; G06V 10/40; G06V 10/764; G06V 10/774

(52) U.S. Cl. CPC G06Q 30/0185; G06T 7/11; G06V 10/40; G06V 10/764; G06V 10/774

(57) ABSTRACT

Authenticating items using a learning model is described. A set of images of an item is received from an image capture system. A set of image segments corresponding to respective images of the set of images is generated by a computing device. A confidence score and/or a binary value that indicates an authenticity of the item is generated as output from a learning model by providing the image segments as input to the learning model. The confidence score is associated with the authenticity of the item. The confidence score is broadcast by the computing device for displaying the authenticity of the item via a user interface. Additionally, or alternatively, one or more data transactions associated with the item are processed or canceled by the computing device based on the binary value and the confidence score.

### BACKGROUND

A computing device may implement machine learning and/or artificial intelligence techniques to generate an output given information, such as a prompt and/or data, as input. For example, the computing device can implement one or more learning models, such as artificial intelligence models and/or machine learning models, to classify input data into a category from a set of defined categories. The learning models may capture patterns and relationships in data, enabling the models to make predictions or decisions on new, unseen data.

### SUMMARY

An item authentication system obtains and analyzes one or more images of an item to determine an authenticity of an item and/or a confidence score related to the authenticity of the item. In some examples, the item authentication system receives the images from an image capture system. The item authentication system evaluates the images to determine whether the item is authentic or is not authentic (e.g., counterfeit). For example, the item authentication system provides the images of the item as input to one or more learning models, and the learning models generate a prediction of the authenticity of the item by dividing the images into respective image segments, performing feature extraction on at least a portion of the image segments, and classifying the extracted features as authentic or counterfeit according to a confidence score. The computing device obtains the classification of the extracted features of the item, including the confidence score, from the item authentication system and broadcasts an indication of whether the item is authentic or not authentic, as well as the confidence score for displaying the authenticity of the item via a user interface. Additionally, or alternatively, the computing device can selectively cancel or process one or more data transactions in accordance with the confidence score.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIGS. 1 and 2 are illustrations of environments in an example implementation that is operable to employ techniques described herein.

FIG. 3 depicts a procedure in an example implementation of authenticating items using a learning model.

FIG. 4 depicts an example of image segmentation for authenticating items using a learning model.

FIG. 5 depicts an example of a machine learning environment for authenticating an item using images of the item.

FIGS. 6 and 7 depict procedures in example implementations of authenticating items using a learning model.

FIG. 8 illustrates an example of a system that includes an example computing device that is representative of one or more computing systems and/or devices that may implement the various techniques described herein.

### DETAILED DESCRIPTION

### Overview

Determining an authenticity of an item using a learning model is described. In accordance with the described techniques, an item authentication system obtains one or more images of an item from an image capture system, which can include an imaging sensor (e.g., a camera) that captures the images of the item. The item authentication system provides the images as input to one or more learning models trained to output a binary value that indicates whether the item is authentic or counterfeit and/or a confidence score. The confidence score indicates a likelihood (e.g., probability, certainty) that the binary value is an accurate prediction of authenticity of the item. For example, the confidence score can be a numerical value, including a percentage or other numerical value, that indicates an estimated accuracy of the binary value. The item authentication system can obtain the binary value and the confidence score as output from the learning models. The item authentication system can display the binary value and/or confidence score at a computing device. Additionally, or alternatively, the item authentication system can determine whether to process and/or cancel one or more data transactions using the binary value and/or the confidence score.

In some examples, one or more original items may be manufactured for sale or distribution. A malicious actor may manufacture alternate versions of the original item, referred to as counterfeit items. Prior to a sale or distribution of an item, the item may be verified as authentic (e.g., confirmed to be an original item) to reduce or prevent fraud related to the sale of counterfeit items. For example, an online marketplace service may receive a request to purchase an item listed for sale via an online marketplace application and may perform an authentication process to verify that the item is authentic. If the item is authentic, then the online marketplace service may process a sale of the item by executing one or more data transaction related to confirmation of the sale and payment for the item, as well as by initiating a shipping process for distribution of the item to an intended recipient. Conventional authentication processes include a human manually evaluating the item to determine an authenticity of the item, including evaluation of one or more aspects (e.g., features and/or) attributes of the item. For example, a human can compare a material of the item to a material of an original item, can determine whether the item includes one or more markings that indicate the authenticity of the item, can compare one or more details including color and/or patterns of the item to the original item, can evaluate information related to the manufacture or distribution of the item, and/or can evaluate metadata related to the item, among evaluating other aspects of the item.

However, a human manually evaluating the item can lead to errors due to lack of training related to evaluating the item and/or differences between the original item and a counterfeit item that are not visible to a human. If the user mistakenly determines a counterfeit item as authentic, then a recipient of the counterfeit item may return the counterfeit item. Returning counterfeit items results in increased computational resources due to a computing device processing the return of the counterfeit item and processing a sale of an additional item to replace the returned counterfeit item. Additionally, or alternatively, a recipient of the counterfeit item may attempt to use the counterfeit item, which could result in data breaches and loss of sensitive information for counterfeit electronic items, inoperability of the counterfeit item, and/or premature failure of the counterfeit item. Further, an online marketplace service may process a relatively large numerical quantity of items (e.g., greater than a threshold numerical quantity of items). A human may be unable to manually verify the authenticity of the items due to the numerical quantity of items processed by the online marketplace service being relatively large.

As described herein, to reduce inefficient use of computational resources, data breaches, and loss of sensitive information due to a counterfeit item being identified as an authentic item, an item authentication system obtains and analyzes one or more images of an item using learning models to determine an authenticity of the item. In some examples, an item authentication system receives the images from an image capture system. The image capture system can include a mechanical platform that can move to capture images of an item on the mechanical platform from different angles and orientations. The image capture system stores the images of the item as they are captured, such that once the images are captured for the item, the image capture system can send the images of the item to the item authentication system.

The item authentication system can provide the images of the item and/or image segments generated from the images as input to one or more learning models. The learning models can generate a prediction of the authenticity of the item by performing feature extraction on at least a portion of the images and/or image segments and classifying the extracted features as authentic or counterfeit according to a confidence score. The computing device obtains the confidence score for the item from the item authentication system and broadcasts the confidence score (e.g., via a user interface of the computing device or another computing device) for displaying the authenticity of the item. Additionally, or alternatively, the computing device can determine whether to cancel or process one or more data transactions related to the item (e.g., a sale of the item and/or a distribution of the item) using the confidence score and/or a binary output from the learning models that indicates that the item is authentic or counterfeit.

Implementing a learning model to determine (e.g., verify) authenticity of the item reduces use of computational resources by increasing an accuracy and consistency of the authenticity verification process and by preventing or reducing processing of data transactions for counterfeit items. For example, increasing the accuracy and consistency of an authenticity verification process can reduce a numerical quantity of data transactions related to inquiries about counterfeit items that are incorrectly identified as authentic and/or processing of returns of the counterfeit items that are incorrectly identified as authentic. Additionally, or alternatively, increasing an accuracy and consistency of the authenticity verification process can lead to reduced data breaches and improved information security related to counterfeit electronic items that are mistakenly identified as authentic items being distributed to users. Further, the item authentication system in conjunction with the image capture system can determine an authenticity of a large numerical quantity of items relative to conventional techniques (e.g., a human manually determining an authenticity of items).

In some aspects, the techniques described herein relate to a computer-implemented method including receiving, from an image capture system, a set of images of an item, generating, by a computing device, a set of image segments corresponding to respective images of the set of images of the item, generating, by the computing device and as output from a learning model, a confidence score associated with an authenticity of the item based on providing the set of image segments as input to the learning model, and broadcasting, by the computing device, the confidence score for displaying the authenticity of the item via a user interface.

In some aspects, the techniques described herein relate to a computer-implemented method, where the learning model includes a feature component and a classifier component, and where generating the confidence score includes receiving, as output from the feature component of the learning model, one or more feature vectors representative of one or more image segments of the set of image segments based on providing the set of image segments as input to the feature component of the learning model, and receiving, as output from the classifier component of the learning model, the confidence score based on providing the one or more feature vectors as input to the classifier component of the learning model.

In some aspects, the techniques described herein relate to a computer-implemented method, where the one or more feature vectors are associated with attributes of the set of image segments.

In some aspects, the techniques described herein relate to a computer-implemented method, further including obtaining training data that includes a set of images of respective items for input to the learning model and an authenticity of the respective items, and training, by minimizing a loss function using the training data, the classifier component of the learning model to determine the confidence score.

In some aspects, the techniques described herein relate to a computer-implemented method, where the confidence score fails to satisfy a threshold value, the computer-implemented method further including receiving, via at least one control of the user interface, an indication of the authenticity of the item, and retraining, by minimizing the loss function using the set of images of the item and the indication of the authenticity of the item, the classifier component of the learning model to determine the confidence score.

In some aspects, the techniques described herein relate to a computer-implemented method, where receiving the one or more feature vectors includes selecting, by the computing device and based at least in part on providing the set of image segments as input to the learning model, the one or more image segments of the set of image segments.

In some aspects, the techniques described herein relate to a computer-implemented method, further including processing a data transaction associated with the item based on the confidence score satisfying a threshold value.

In some aspects, the techniques described herein relate to a computer-implemented method, further including causing display of a control at the user interface, wherein the control is selectable to indicate a first value or a second value associated with a true authenticity of the item based on the confidence score failing to satisfy a threshold value.

In some aspects, the techniques described herein relate to a computer-implemented method, further including receiving a selection of the first value via the control and processing a data transaction associated with the item based on the selection.

In some aspects, the techniques described herein relate to a computer-implemented method, further including receiving a selection of the second value via the control, and canceling processing of a data transaction associated with the item based on the selection.

In some aspects, the techniques described herein relate to a system including one or more processors, and a computer-readable storage medium storing instructions that are executable by the one or more processors to perform operations including receiving, from an image capture system, a set of images of an item, generating, by a computing device, a set of image segments corresponding to respective images of the set of images of the item, generating, by the computing device and as output from a learning model, a confidence score associated with an authenticity of the item based on providing the set of image segments as input to the learning model, and broadcasting, by the computing device, the confidence score for displaying the authenticity of the item via a user interface.

In some aspects, the techniques described herein relate to a computer-implemented method including receiving, from an image capture system, a set of images of an item, generating, by a computing device, a set of image segments corresponding to respective images of the set of images of the item, generating, by the computing device and as output from a learning model, a binary value that indicates an authenticity of the item and a confidence score associated with the authenticity of the item based on providing the set of image segments as input to the learning model, and processing or canceling, by the computing device, one or more data transactions associated with the item based on the binary value that indicates the authenticity of the item and the confidence score associated with the authenticity of the item.

In some aspects, the techniques described herein relate to a computer-implemented method, where processing or canceling the one or more data transactions associated with the item includes processing the one or more data transactions based on the binary value that indicates the authenticity of the item indicating that the item is authentic and based on the confidence score satisfying one or more threshold values.

In some aspects, the techniques described herein relate to a computer-implemented method, where processing or canceling the one or more data transactions associated with the item includes canceling the one or more data transactions based on the binary value that indicates the authenticity of the item indicating that the item is counterfeit and based on the confidence score satisfying one or more threshold values.

In some aspects, the techniques described herein relate to a computer-implemented method, further including determining the confidence score fails to satisfy at least one threshold value, causing display of a control at a user interface, wherein the control is selectable to indicate a true authenticity of the item based on the confidence score failing to satisfy the at least one threshold value and receiving a selection via the control.

In some aspects, the techniques described herein relate to a computer-implemented method, where processing or canceling the one or more data transactions associated with the item includes processing the one or more data transactions based on the selection indicating that the true authenticity of the item is authentic.

In some aspects, the techniques described herein relate to a computer-implemented method, where processing or canceling the one or more data transactions associated with the item includes canceling the one or more data transactions based on the selection indicating that the true authenticity of the item is counterfeit.

In some aspects, the techniques described herein relate to a computer-implemented method, further including retraining the learning model based on the selection and the set of image segments.

In some aspects, the techniques described herein relate to a computer-implemented method, where the one or more data transactions are associated with one or more of a distribution of the item or a sale of the item.

In some aspects, the techniques described herein relate to a computer-implemented method, where the learning model includes a feature component and a classifier component, and where generating the binary value that indicates the authenticity of the item and the confidence score associated with the authenticity of the item includes receiving, as output from the feature component of the learning model, one or more feature vectors representative of one or more image segments of the set of image segments based on providing the set of image segments as input to the feature component of the learning model, and receiving, as output from the classifier component of the learning model, the binary value that indicates the authenticity of the item and the confidence score associated with the authenticity of the item based on providing the one or more feature vectors as input to the classifier component of the learning model.

### Example of an Environment

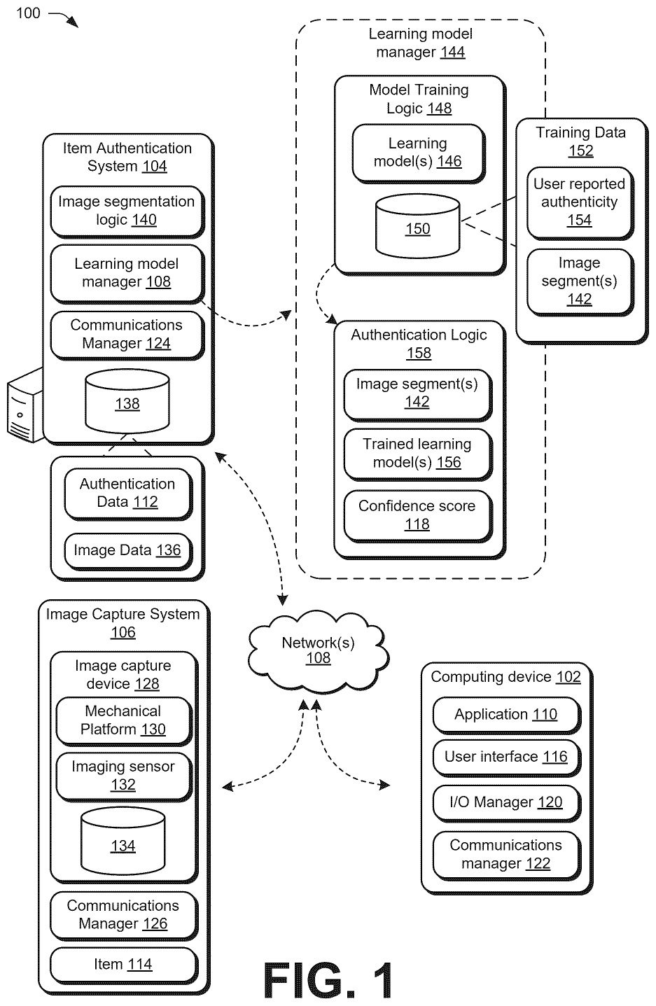

FIG. 1 is an illustration of an environment 100 in an example implementation that is operable to employ techniques described herein. The environment 100 includes a computing device 102, an item authentication system 104, and an image capture system 106. In one or more implementations, the computing device 102, the item authentication system 104, and the image capture system 106 are communicatively coupled, one to another, via network(s) 108. One example of the network(s) 108 is the Internet, although the computing device 102, the item authentication system 104, and the image capture system 106 may be communicatively coupled using one or more different connections or different networks 108 (e.g., wireless networks) in various implementations.

Although the item authentication system 104 is depicted in the environment 100 as being separate from the computing device 102, in one or more implementations, an entirety, or various portions of the item authentication system 104 are implemented at or by the computing device 102. In at least one implementation, for example, at least a portion of the item authentication system 104 is implemented by an application 110 of the computing device 102 and/or using various resources of the computing device 102, such as hardware resources, an operating system, firmware, and so forth. Alternatively, or additionally, the item authentication system 104 is implemented by server-based storage resources, processing resources, and so on of devices other than the computing device 102. For example, at least a portion of the item authentication system 104 is implemented using a third-party service, such as a web services platform that provides one or more hardware and/or other computing resources to support provision of services by web service providers. In variations, an entirety, or various portions of the item authentication system 104 are implemented at or by a device of the user (e.g., a mobile device, a laptop, a wearable device, or any other device).

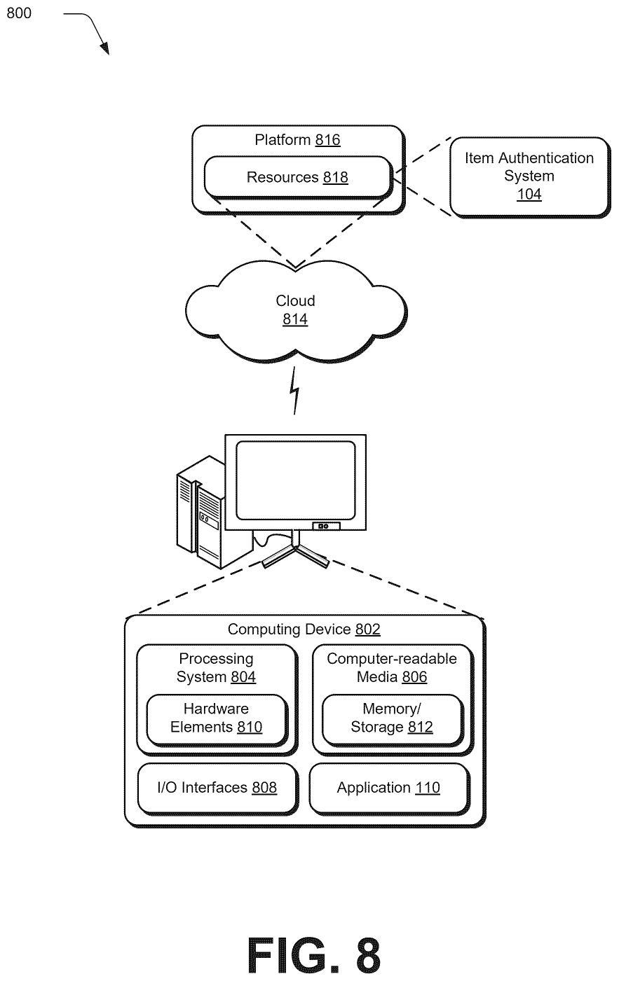

A computing device 102 that implements the environment 100 is configurable in a variety of ways. A computing device 102, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an augmented reality and/or virtual reality device (e.g., the smart glasses), a server, and so forth. Thus, a computing device 102 ranges from full resource devices with substantial memory and processor resources to low-resource devices with limited memory and/or processing resources. Although in instances in the following discussion reference is made to a computing device 102 in the singular, a computing device 102 may also be representative of multiple different devices, such as multiple servers of a server farm utilized to perform operations “over the cloud” as further described in relation to FIG. 8.

In at least one implementation, the application 110 supports communication of data across the network(s) 108 between the computing device 102, the image capture system 106, and the item authentication system 104. By supporting such data communication, the application 110 provides a respective user of the computing device 102 (e.g., and users of other computing devices) access to authentication data 112 for one or more items 114. For example, the computing device 102 receives the authentication data 112 from the item authentication system 104. Based on the received authentication data 112, the application 110 causes various systems of the computing device 102 to output one or more user interfaces 116, such as by displaying the user interfaces 116 via display devices or making accessible voice-based user interfaces.

Through interaction of a user with the computing device 102, the application 110 receives user input via the user interfaces 116. Examples of such input include, but are not limited to, receiving touch input in relation to portions of a displayed user interface, receiving one or more voice commands or other audio input, receiving typed input (e.g., via a physical or virtual (“soft”) keyboard), receiving mouse or stylus input, and so forth. One example of the application 110 is a browser or other web application that facilitates user interaction with authentication data 112. Another example of the application 110 is a web-based computer application that facilitates user interaction with authentication data 112, such as a mobile application or a desktop application. The application 110 may be configured in different ways, which enable users to interact with the computing device 102 and by extension perform actions to view, sort, or otherwise interact with the authentication data 112, without departing from the spirit or scope of the techniques described herein.

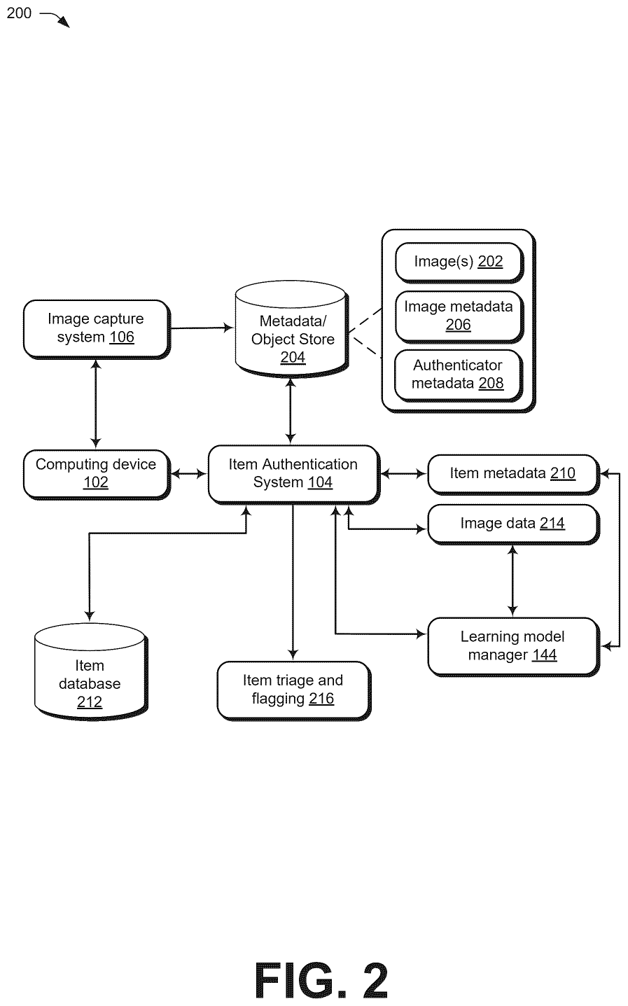

In some examples, the item authentication system 104 can maintain authentication data 112 for one or more items 114. The authentication data 112 can include authenticator metadata, which is described in further detail with respect to FIG. 2. Additionally, or alternatively, the authentication data 112 can include an indication of an authenticity of the item 114 and/or a confidence score 118 related to the indication of the authenticity of the item 114. The indication of the authenticity of the item 114 can include a binary value that indicates whether the item 114 is authentic or counterfeit (e.g., not authentic, inauthentic). The confidence score 118 can be a numerical value, such as a percentage, that indicates a likelihood that the indication of authenticity is accurate or correct.

In some examples, the items 114 can include one or more items 114 of various types of physical goods or property, such as components of a device or apparatus, accessories of a device or apparatus, clothing and/or clothing accessories, collectibles, furniture, decorative items, textiles, luxury items, electronics, real property, physical computer-readable storage having one or more video games stored thereon, and so on, to name just a few. The items 114 can be listed for sale via an online marketplace, where the application 110 can be an online marketplace application. Broadly speaking, the online marketplace is configured to generate listings for items 114 and to expose those listings (e.g., publish them) to one or more computing devices 102. For example, the online marketplace may generate listings for items 114 for sale and expose those listings to a computing device 102, such that the users of the computing device 102 can interact with the listings via user interfaces to initiate data transactions (e.g., purchases, add to wish lists, share, and so on) in relation to the respective item 114 or items 114 of the listings.

In some examples, the listing for the item 114 can include information that indicates the authenticity of the item 114, such as the binary value that indicates the authenticity and/or the confidence score 118. In some variations, a field in the listing of the item 114 can indicate that the item 114 is authentic, and an associated confidence score 118. For example, the computing device 102 can display a user interface 116 including the listing for the item 114 that includes an “Authenticity” field that indicates a percentage representative of the likelihood that the item 114 is authentic.

In some cases, the application 110 can be used for monitoring and processing items, such as monitoring and processing distribution of the items 114 to an intended recipient (e.g., a user of the online marketplace application that initiates a data transaction to purchase the item 114). For example, the application 110 can cause indications of authenticity of different items 114 that are to be processed and/or distributed to one or more intended recipients and/or the corresponding confidence scores 118 for the indications of authenticity to be broadcast for display via the user interface 116 of the computing device 102 or via a user interface of another computing device.

For example, the computing device 102 can broadcast (e.g., output) the confidence scores 118 and/or a binary value that indicates the authenticity of an item 114 to a user via a user interface 116 of the computing device 102. In some other examples, the computing device 102 can broadcast (e.g., transmit, send) the confidence scores 118 and/or a binary value that indicates the authenticity of an item 114 to another computing device via the network(s) 108. The other computing device can display an indication of whether the item is authentic or counterfeit (e.g., the confidence score 118 and/or the binary value). Additionally, or alternatively, the computing device 102 can display the indication of whether the item is authentic or counterfeit via the user interface 116. The computing device 102 and/or the other computing device can display the confidence score and/or the binary value directly or can display a message that indicates whether the item is authentic or counterfeit. For example, if the binary value indicates the item is counterfeit and the confidence score 118 is greater than a threshold value, then the computing device 102 and/or the other computing device can display a message “Warning, this item is counterfeit.” If the binary value indicates that the item is authentic and the confidence score 118 is greater than a threshold value, then the computing device 102 and/or the other computing device can display a message “This item is authentic.” The content of the message can depend on the confidence score 118 in addition to the binary value. For example, if the confidence score 118 fails to satisfy the threshold value, then the computing device 102 and/or the other computing device can display a message “This item is likely counterfeit,” “This item is likely authentic,” or “There is a 76% chance that this item is counterfeit,” if the threshold is 80%, as an example.

The computing device 102 can receive user input via an I/O manager 120 that causes the computing device to execute instructions, such as to cause the computing device 102 to cancel processing of items 114 that are indicated as counterfeit or to continue processing of items 114 that are indicated as authentic. The user input can additionally, or alternatively, cause the computing device 102 to transmit a notification to an intended recipient of the item 114 that indicates that the item 114 is counterfeit or authentic based on the indication of authenticity for the item.

In variations, the computing device 102 may collect user input and provide information to a user using an I/O manager 120. The I/O manager may configure the computing device 102 to display, or otherwise present, controls that are selectable by a user to provide user input and/or prompts requesting user input. In some examples, the I/O manager 120 displays the controls and/or prompts to the user via a graphical user interface (GUI) of a computing device 102 (e.g., via the user interface 116). In some other examples, the I/O manager 120 displays the request to the user via a GUI of another device communicatively coupled with the computing device 102 (e.g., another computing device 102 coupled with the computing device 102 via the networks 108). The I/O manager 120 can visually display the controls and/or the prompts, can emit an audio version of the controls and/or the prompts via an audio output component, or the like.

In some examples, the I/O manager 120 receives user input via one or more input components of the user interface 116. The user input may be in response to a request for user input from the computing device 102 and/or may be initiated by a user of the computing device 102. Examples of such user input include, but are not limited to, receiving touch input in relation to portions of a displayed user interface, receiving one or more voice commands, receiving typed input (e.g., via a physical or virtual (“soft”) keyboard), receiving mouse or stylus input, and so forth. For example, the user input can include a request to via authentication data 112 for one or more items 114, a request to sort the authentication data 112 for the one or more items 114 (e.g., by confidence score 118 and/or by binary values that indicate the authenticity of the items 114), an indication to cancel processing of an item 114 for distribution, an indication to transmit a message to another computing device 102 that indicates to a user of the computing device the authenticity of the item 114, or any other user input.

In some examples, the computing device 102, the item authentication system 104, and the image capture system 106 implement a communications manager 122, a communications manager 124, and a communications manager 126, respectively, to support communication of data across the network(s) 108 between the computing device 102, the item authentication system 104, and the image capture system 106. By supporting such data communication, the communications manager 122 and the communications manager 124 provide the computing device 102 access to authentication data 112 from the item authentication system 104 otherwise inaccessible by the computing device 102. The communications manager 124 and the communications manager 126 provides the item authentication system 104 access to images of items 114 obtained by the image capture system 106, which the item authentication system 104 can use to generate at least a portion of the authentication data 112.

In some examples, the image capture system 106 can include an image capture device 128, such as an image capture robot that includes a mechanical platform 130, an imaging sensor 132, and data storage 134. The image capture system 106 may obtain one or more items 114 for which an item authentication system 104 is to determine an authenticity. The mechanical platform 130 can include one or more actuators that move a platform to different angles, which provides for the imaging sensor 132 to capture images of an item 114 on the platform from the different angles. In some examples, a material of the platform can be translucent, so as to provide for imaging of an item 114 through the platform. The image capture system 106 can send instructions to the mechanical platform 130 and to the imaging sensor 132 to indicate for the mechanical platform 130 to move to a set of defined locations and for the imaging sensor 132 to capture a set of images once the mechanical platform 130 is at respective locations from the set of defined locations.

In some cases, the imaging sensor 132 can include a camera or any other type of imaging sensor that captures still photographs of an item 114 on the mechanical platform 130 at the respective defined locations. In some other cases, the imaging sensor 132 can include a camera or any other type of imaging sensor that captures a video of the item 114 on the mechanical platform 130 as the mechanical platform moves the item 114 to the different defined locations. The photographs of the item 114 and/or the video of the item 114, which are referred to as images herein, can include macroscopic views of the item 114 (e.g., in addition to, or as an alternative to, microscopic views of the item 114). The macroscopic views can include an entirety of the item. For example, the images can include a top view of the item 114, one or more side views of the item 114, and a bottom view of the item 114 (e.g., through the mechanical platform 130). The image capture device 128 can store the photographs and/or the video as they are captured at the data storage 134.

The data storage 134 may represent one or more databases and/or other types of storage capable of storing the images. Examples of the data storage 134 include, but are not limited to, mass storage and virtual storage. In one or more implementations, for example, the data storage 134 may be virtualized across multiple data centers and/or cloud-based storage devices. The image capture system 106 can access the data storage 134 to obtain a sequence or set of images of an item 114 once the images of the item 114 are captured from the defined set of locations (e.g., from different angles). The image capture system 106 can transmit the images of the item 114 to the computing device 102 and/or to the item authentication system 104. For example, the image capture system 106 can transmit the images of the item 114 directly to the item authentication system 104 for determining an authenticity of the item 114. In some other examples, the image capture system 106 can transmit the images of the item 114 to the computing device 102, and the computing device 102 can transmit the images of the item 114 to the item authentication system 104.

In some examples, the item authentication system 104 can store image data 136 at a data storage 138 of the item authentication system 104. The data storage 138 may represent one or more databases and/or other types of storage capable of storing the images. Examples of the data storage 138 include, but are not limited to, mass storage and virtual storage. In one or more implementations, for example, the data storage 138 may be virtualized across multiple data centers and/or cloud-based storage devices. The image data 136 can include raw image data obtained from the imaging sensor 132, as well as image metadata, which is described in further detail with respect to FIG. 2.

In some examples, the item authentication system 104 can process the raw image data (e.g., the still photographs and/or the video). Additionally, or alternatively, the image capture system 106 can process the raw image data prior to transmitting the images including the image data 136 to the item authentication system 104. For example, the item authentication system 104 and/or the image capture system 106 can crop one or more of the images to remove portions of the image that do not include the item 114. Additionally, or alternatively, the item authentication system 104 can include image segmentation logic 140 that causes the item authentication system 104 to process an image by splitting or dividing the image into a numerical quantity of image segments 142 (e.g., segments, tiles) that include a visual representation of different portions of the item in the image. In some examples, the respective images of an item 114 are divided into a same numerical quantity of image segments 142. In some other examples, the respective images of an item 114 are divided into a different numerical quantity of image segments 142.

The image segmentation logic 140 can determine a numerical quantity of image segments 142 using a level of detail in the image, a size of the image, a perspective of the item in the image, or any other factor. For example, an image with a relatively high variation in color and/or patterns (e.g., high level of detail) can be divided into a greater numerical quantity of image segments 142, while an image with a relatively low variation in color and/or pattern (e.g., a low level of detail) can be divided into a lower numerical quantity of image segments 142. A relatively large image (e.g., greater than a threshold resolution and/or size) can be divided into a greater numerical quantity of image segments 142 when compared with a relatively small image (e.g., less than a threshold resolution and/or size). An image that includes a relatively great portion of the item 114 can be divided into a greater numerical quantity of image segments 142 when compared with an image that includes a relatively small portion of the item 114 (e.g., an image of a side view of a shoe can include a greater portion of the shoe when compared with an image of a front view or back view of the shoe).

In some examples, the item authentication system 104 includes a learning model manager 144 to train, fine-tune, and/or implement one or more learning models 146. The item authentication system 104 can provide the image segments and/or images of an item 114 to the learning model manager 144 to determine an authenticity of the item 114. In one or more implementations, the item authentication system 104 may implement the learning model manager 144 by using servers that execute stored instructions to deploy various services of the item authentication system 104, such that those services perform numerous computations which are effective to provide the functionality described above and below. It is to be appreciated that the learning model manager 144 may include more, fewer, or different components without departing from the spirit or scope described herein.

In this example, the learning model manager 144 includes, or otherwise has access to, the model training logic 148. The learning model manager 144 can utilize the model training logic 148 to train or fine-tune one or more learning models 146 (e.g., machine learning models, artificial intelligence models). Example learning models 146 include, but are not limited to, neural networks, support vector machines (SVMs), logistic regression models, and/or classifier models, among other examples.

In some examples, learning models 146 can be fine-tuned, or trained, for a specific application (e.g., use case) using data for the specific application. Fine-tuning a learning model 146 may include updating an existing, or pre-trained, learning model 146 by training the learning model 146 with a more specific dataset to adapt the learning model 146 to a task or context. The model training logic 148 is configured to access a data storage 150, which is depicted maintaining training data 152, by executing a retrieve command to obtain the training data 152. The data storage 150 may represent one or more databases and/or other types of storage capable of storing the training data 152. Examples of the data storage 150 include, but are not limited to, mass storage and virtual storage. In one or more implementations, for example, the data storage 150 may be virtualized across multiple data centers and/or cloud-based storage devices.

In some examples, the training data 152 includes user reported authenticity 154 and/or image segments 142 generated by the image segmentation logic 140. For example, the computing device 102 and/or the image capture system 106 may transmit data to the item authentication system 104 that includes a user reported authenticity 154 for one or more items 114 and corresponding images and/or image segments 142 of the items 114. The user reported authenticity 154 for the one or more items 114 can include an indication of whether an item is authentic and/or counterfeit for a set of items 114. The user reported authenticity 154 can be provided via user input at the computing device 102.

Once the learning model manager 144 of the item authentication system 104 obtains the training data 152, the item authentication system 104 can instruct the learning model manager 144 to generate one or more trained machine learning models 156 for determining an authenticity of an item from image segments 142 and a corresponding confidence score 118 that represents a likelihood that the authenticity of the item is accurate or correct. In some cases, the learning model manager 144 may implement a supervised learning approach, such that the model training logic 148 causes the learning model manager 144 to train the learning models 146 using one or more images of respective items and corresponding indications of authentic or counterfeit, where the indication is the label for the images of the respective items. A supervised learning approach includes collecting training data 152 that has respective data samples that include one or more input features and a corresponding target output (e.g., images and/or image segments 142 of an item 114 and corresponding user reported authenticity 154 that indicates the authenticity of the item 114).

To train the learning models 146, the model training logic 148 can cause the learning model manager 144 to initialize one or more model parameters (e.g., weights and/or biases of the learning model). The model training logic 148 can cause the learning model manager 144 to provide the training data 152 to the learning models 146 to update the model parameters according to the training data 152. For example, the item authentication system 104 can request user reported authenticity 154 for a set of items 114 from the computing device 102. In some cases, the computing device 102 can display the request via the user interface 116 and can receive the user reported authenticity 154 responsive to displaying the request. In some other cases, the item authentication system 104 and/or the computing device 102 can access a database that maintains the user reported authenticity 154 for the set of items 114. The image capture system 106 can provide images of the set of items 114 to the item authentication system 104. The item authentication system 104 can implement the image segmentation logic 140 to obtain the image segments 142 from the images of the set of items 114. The item authentication system 104 can provide the user reported authenticity 154 and the image segments 142 to the learning model manager 144 to use as training data 152.

The model training logic 148 can include instructions that cause the learning model manager 144 to provide the training data 152 (e.g., a portion of the training data 152 or all of the training data 152), including the image segments 142 and the user reported authenticity 154 for the set of items 114, as input to the learning models 146. The learning models 146 can provide an output, such as a prediction of whether respective items 114 are authentic based on the image segments 142. The learning model manager 144 can measure a difference between the prediction and the user reported authenticity 154 using a loss function (e.g., a mean squared error (MSE) function, a cross entropy loss function, or any other loss function). The learning model manager 144 can compute gradients of the loss with respect to the model parameters using backpropagation and/or other analytical methods. The learning model manager 144 can update one or more model parameters to minimize the loss, such as by minimizing the difference between the prediction and the user reported authenticity 154. Thus, the learning model manager 144 can generate one or more trained learning models 156 that represent customized learning models for outputting a prediction of whether an item 114 is authentic or counterfeit using image segments 142 from macroscopic images of the item 114 (e.g., without directing the learning model 146 to an area of interest by using microscopic images of the item 114).

In some cases, the learning model manager 144 can train multiple learning models 146 and can select a trained learning model 156 with a greatest performance (e.g., accuracy and precision, among other performance metrics) to use for determining an authenticity of an item 114. In some examples, the learning model manager 144 can cluster authentic items and counterfeit items by performing anomaly detection and can use the clusters to train the learning models 146. For example, during training the learning model manager 144 can determine one or more image embeddings (e.g., arrays of an image) for authentic items 114 are closer (e.g., clustered) and the image embeddings of counterfeit items 114 are farther apart or outside of the cluster. Using clusters to determine authenticity of an item can be referred to as a metric and/or contrastive learning techniques, where the embeddings are separated based on similarity.

In some examples, the learning model manager 144 can train the learning models 146 to output a confidence score 118 that represents a likelihood (e.g., certainty, probability) that the prediction of whether the item 114 is authentic, or counterfeit is accurate. For example, the learning model manager 144 can use the difference between the prediction and the user reported authenticity 154, as well as one or more features extracted from the image segments 142 when training the learning models 146 to generate a confidence in the prediction. The confidence score 118 can include a percentage (e.g., out of 100%) that the prediction is accurate, or any other representation of a likelihood that the prediction is accurate.

In some examples, the model training logic 148 may include instructions to continue to train the learning models 146 until a defined numerical quantity of predictions of authenticity for a set of items 114 have a corresponding confidence score 118 that satisfies a threshold value. The item authentication system 104 may receive user input (e.g., via the computing device 102) that indicates the defined numerical quantity of predictions and/or the threshold value. Additionally, or alternatively, the defined numerical quantity of predictions and/or the threshold value can be defined as default values by the item authentication system 104. Although the training data 152 is illustrated as including image segments 142, the learning model manager 144 can additionally, or alternatively, provide entire images (e.g., without having been divided into image segments 142) to the learning models 146.

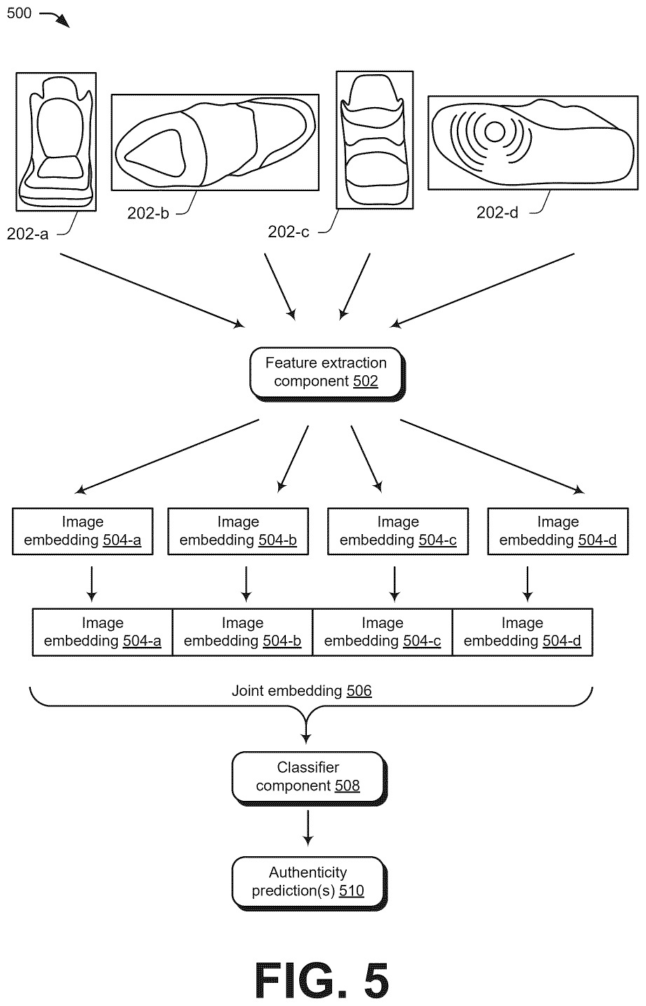

In some cases, the learning models 146 can include a feature extraction component and a classifier component (a linear classifier, a tree, etc.), which is described in further detail with respect to FIG. 5. The feature extraction component can determine a structure of an image (e.g., one or more features of an image) by identifying edges or boundaries of an item 114 within the image, as well as by analyzing a gradient and orientation of the image. The extracted features can be sorted into a defined set of categories by a classifier component of the learning models 146. For example, the learning models 146 can extract one or more features of an item 114 from one or more images and/or image segments 142 provided as input to the learning models 146. The learning models 146 can classify the item 114 as authentic or counterfeit by using a classifier component of the learning models 146. In some examples, the learning model manager 144 can train the classifier component to sort an item into one of two categories, including an authentic item category and a counterfeit item category. Additionally, or alternatively, the learning model manager 144 can train the classifier component to determine a confidence score 118 that the item is correctly sorted into the category. The training can include minimizing a loss function using the training data 152.

In some cases, the learning model manager 144 includes authentication logic 158 for predicting an authenticity of an item 114 using the trained learning models 156. The authentication logic 158 can include instructions that cause the learning model manager 144 to provide image segments 142 (e.g., different image segments 142 than those provided during training of the learning model) to the trained learning models 156. The trained learning models 156 can generate respective predictions of whether one or more items 114 represented in the image segments 142 are authentic or counterfeit, as well as confidence scores 118 in the predictions. The prediction of whether an item 114 is authentic, or counterfeit can include a binary value (e.g., a first value for counterfeit and a second value for authentic).

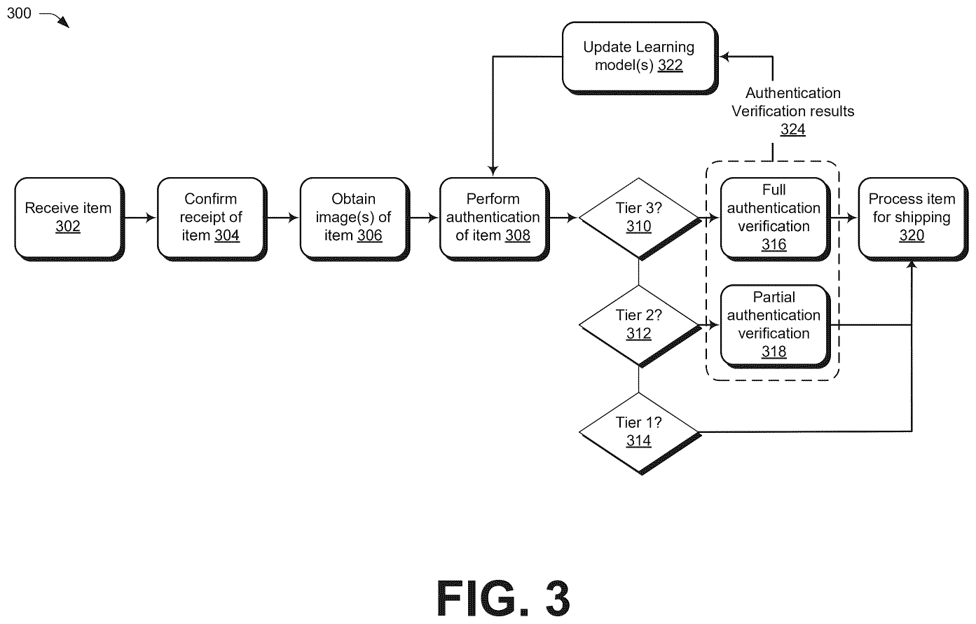

In some examples, the item authentication system 104 can evaluate the confidence score 118 and determine whether to further verify the authenticity of the item 114 according to a tiered system, which is described in further detail with respect to FIG. 3. If the item authentication system 104 determines not to perform further verification of authenticity of an item 114 (e.g., the confidence score 118 exceeds one or more threshold values), then the item authentication system 104 can store the prediction of authenticity, and optionally the confidence score 118, at a data storage 138 (e.g., as authentication data 112). If the item authentication system 104 determines to perform further verification of authenticity of an item 114, then the item authentication system 104 can transmit a request to the computing device 102 for the further verification of authenticity of the item 114. The computing device 102 can display a request for a user of the computing device 102 to verify the authenticity of the item 114 (e.g., manually). The computing device 102 can receive an indication of authenticity of the item 114 as user input and can send the indication of authenticity of the item 114 to the item authentication system 104. The item authentication system 104 can store the indication of authenticity of the item 114 at the data storage 138.

In some examples, the item authentication system 104 can continue to fine-tune the trained learning models 156 once they are implemented to determine authenticities of items 114. For example, the item authentication system 104 can use the user input that indicates the authenticity of the item 114, as well as images and/or image segments 142 corresponding to the item 114 as additional training data 152 to fine-tune or refine the parameters of the trained learning models 156. Thus, the trained learning models 156 can be further updated (e.g., retrained, customized) to increase an accuracy of a prediction of authenticity of items 114, as well as to ensure the trained learning models 156 remain current with respect to items 114 (e.g., as trends change and/or new items 114 are produced).

In some examples, the learning model manager 144 can implement a learning model (e.g., a same learning model as the learning models 146 and/or a different learning model) to evaluate and select one or more image segments 142 of the image segments 142 provided as input to the learning model. For example, one or more of the image segments 142 may not contribute to the determination of authenticity of an item 114. The learning model can extract one or more features from an image and/or from the image segments 142 (colors, patterns, edges, etc.), and can select image segments 142 with features relevant to the authenticity of the item 114. Thus, the learning model manager 144 can reduce an amount or numerical quantity of processing resources used by the trained learning models 156 to process the image segments 142 by selecting image segments 142 that contribute to and/or are relevant to determining the authenticity of the item 114.

Due to the relatively large numerical quantity of items 114 processed by the item authentication system 104 (e.g., items 114 listed for sale on the online marketplace, among other examples), a user may be unable to manually determine an authenticity of the respective items 114. Thus, by implementing the trained learning models 156, the item authentication system 104 is able to identify and/or detect counterfeit items 114 for reporting to a user and/or for canceling data transactions related to processing of the item 114 for sale or distribution (e.g., without a user manually canceling the data transactions). For example, the item authentication system 104 may report the authenticity of an item 114 and the confidence score to a user (e.g., a vendor of the item 114 and/or a buyer of the item 114 if the item 114 is an item for sale) via a computing device 102. The item authentication system 104 can additionally, or alternatively, transmit the data to the computing device 102 to use for listing the item 114 for sale (e.g., if the item 114 is authentic) and/or for canceling listing of the item 114 for sale (e.g., if the item 114 is counterfeit).

The item authentication system 104 may use the learning models 146 to build a self-learning system that analyzes images and/or image segments 142 of items 114 to reduce or prevent counterfeit items 114 from being listed for sale at an online marketplace and/or otherwise distributed. The self-learning system may analyze the image segments 142, determine an authenticity of items 114 corresponding to the image segments 142, and provide the authenticity of the items 114 to a user or otherwise process the item 114 according to the authenticity of the items 114 (e.g., cancel a data transaction and/or listing of an item 114 determined to be counterfeit or processing a data transaction and/or listing of an item 114 determined to be authentic). One or more users may be unable to determine authenticity of the items 114 manually due to the relatively large numerical quantity of items 114 processed and/or distributed (e.g., for the online marketplace), as well as the complexity and diversity of the types of items 114.

The item authentication system 104 may implement the image segmentation logic 140, the model training logic 148, and the authentication logic 158 by using servers that execute stored instructions to deploy various services of the item authentication system 104, such that those services perform numerous computations which are effective to provide the functionality described above and below. It is to be appreciated that the item authentication system 104, the image capture system 106 and/or the computing device 102 may include more, fewer, or different components without departing from the spirit or scope described herein.

Having considered an example of an environment, consider now a discussion of some example details of the techniques for authenticating items using a learning model in accordance with one or more implementations.

### Determining Authenticity of an Item Using Learning Models

FIG. 2 is an illustration of an environment 200 in an example implementation that is operable to employ techniques described herein. The environment 200 includes a computing device 102, an item authentication system 104, and an image capture system 106, which may be examples of the corresponding devices and systems as described with reference to FIG. 1. For example, the item authentication system 104 can implement a learning model manager 144, which can be an example of the learning model manager 144 as described with reference to FIG. 1, to determine authenticities of respective items.

In some examples, conventional techniques for determining authenticity of items, including items listed for sale and/or distributed to an intended recipient, can include a human manually analyzing the items and providing user input that indicates whether the item is authentic or counterfeit. However, a human manually analyzing an item can be time consuming, resulting in a relatively small numerical quantity of items analyzed over a period of time (e.g., less than a threshold numerical quantity of items being analyzed over the period of time). Additionally, or alternatively, a human manually analyzing the item can lead to errors due to lack of training, differences that are not perceptible to a human, and/or lack of care or consistency in the analysis of the item, among other examples. The errors can include items that are counterfeit being incorrectly identified as authentic and/or items that are authentic being incorrectly identified as counterfeit.

In some cases, the counterfeit items that are incorrectly identified as authentic may be returned (e.g., by an intended recipient), resulting in additional processing and signaling overhead related to communications and data transactions resulting from the returned counterfeit items and/or distributing replacement items for the returned counterfeit items. In some other cases, an intended recipient may use the counterfeit items, resulting in a multitude of safety concerns related to data security of the intended recipient (e.g., if the item is a counterfeit electronic item with malicious software and/or hardware) and/or poor manufacture of the counterfeit item resulting in premature failure of the item, among other safety concerns. In some examples, data transactions related to a sale and/or distribution of authentic items that are incorrectly identified as counterfeit items can be canceled unnecessarily, resulting in increased usage of computational resources (e.g., processing and memory resources) to process the cancelation of the data transactions and/or to process additional data transactions related to a replacement item.

In some examples, an item authentication system 104 can implement one or more learning models to determine whether items are authentic or counterfeit due to the relatively large numerical quantity of items that are analyzed for authenticity prior to sale and/or distribution (e.g., hundreds of thousands of items listed for sale on an online marketplace application), as well as to address errors resulting from conventional techniques for analyzing authenticity of the items. The image capture system 106 can obtain one or more images 202 of respective items. The images 202 can include one or more still images of the items and/or a series of images that make up a video of the items. The image capture system 106 can store the images 202 at a metadata/object store 204, which can be an example of the data storage 134, the data storage 138, and/or the data storage 150, as described with reference to FIG. 1. The metadata/object store 204 can be accessible by the item authentication system 104 and/or the image capture system 106.

The image capture system 106 can additionally, or alternatively, store image metadata 206 at the metadata/object store 204, where the image metadata 206 can include information embedded within an image file that provides details about a corresponding image 202. The image metadata 206 can include technical details about how the image 202 was created, information about the content of the image 202, and/or structural data. The technical details about how the image 202 was created can include a type of an imaging sensor (e.g., a camera model), one or more settings of the imaging sensor when the image 202 was captured, a date and/or time the image 202 was captured, and/or a location where the image 202 was captured, among other details. The information about the content of the image 202 can include a name or title of the image 202, a description of the image content, and/or one or more keywords and/or tags that indicate a category of the item in the image 202, among other information. The structural data can include a file size of the image 202, a color of the image 202, and/or a level of compression or details related to any processing applied to the image 202.

In some examples, the item authentication system 104 can store authenticator metadata 208 at the metadata/object store 204. The authenticator metadata 208 can include details related to whether an item is to be authenticated manually (e.g., by a human) and/or by the item authentication system 104 using learning models. The authenticator metadata 208 can additionally, or alternatively, include a location of authentication of the item, details related to a data transaction if the item is determined to be authentic, one or more thresholds related to a confidence score for the authentication of the item, and/or details related to initialization of one or more parameters of the learning models, among other information.

In some examples, the item authentication system 104 can receive signaling (e.g., from the computing device 102 and/or from the image capture system 106) that triggers data collection for determining an authenticity of an item. In some examples, the signaling can indicate a unique identifier corresponding to an item that is to be authenticated (e.g., a license plate number (LPN) identifying the item). The data collection can include the item authentication system 104 obtaining one or more images 202 of the item from the metadata/object store 204, obtaining the image metadata 206 from the metadata/object store 204, and/or obtaining the authenticator metadata 208 from the metadata/object store 204. The item authentication system 104 can additionally, or alternatively, obtain item metadata 210 from an item database 212. The item metadata 210 can be assigned to and/or labeled with the item identifier corresponding to the item. The item metadata 210 can include a location of the item, a type and/or category of the item, information related to whether the item is listed for sale, and/or data transactions that are to be processed upon authentication of the item, among other information.

The item authentication system 104 can provide the item metadata 210 and/or image data 214 (e.g., the images 202, image segments obtained from the images 202, and/or the image metadata 206) to a learning model manager 144. In some examples, the item authentication system 104 can process the images 202, such as to crop the images 202 and/or to generate image segments for respective images 202. Additionally, or alternatively, the learning model manager 144 can process the images 202 prior to providing the images 202 and other data (e.g., the image data 214 and/or the item metadata 210) as input to the learning models. The learning model manager 144 can provide the image data 214 and/or the item metadata 210 as input to one or more trained learning models, as described with reference to FIG. 1. The trained learning models can provide a binary value that indicates whether the item is authentic or counterfeit as output. Additionally, or alternatively, the trained learning models can provide a confidence score that indicates a likelihood that the item is authentic or counterfeit, such as a percentage that the binary value is correct.

The item authentication system 104 can receive the binary value that indicates whether the item is authentic or counterfeit (e.g., authentication label) and the confidence score from the learning model manager 144. The item authentication system 104 can determine whether or not to verify the binary value for one or more items by performing item triage and flagging 216, which is described in further detail with respect to FIG. 3. In some examples, if the item authentication system 104 determines that the item is authentic (e.g., from the binary value, the confidence score, and/or a further verification of the authenticity of the item), then the item authentication system 104 can process the item for shipping and/or distribution. In some other examples, if the item authentication system 104 determines the item is counterfeit, then the item authentication system 104 can cancel one or more data transactions related to processing the item for shipping and/or distribution.

The item authentication system 104 can transmit singling to the computing device 102 that indicates whether the item is authentic or counterfeit. Additionally, or alternatively, the item authentication system 104 can store the binary value that indicates whether the item is authentic or counterfeit and/or the confidence score in the item database 212. The computing device 102 can access the item database 212 to retrieve the binary value and/or the confidence score when generating a listing for sale of the item and/or when processing one or more data transactions for distribution or sale of the item. In some cases, the computing device 102 can populate one or more fields of an item listing with a binary value that indicates the item is authentic (e.g., for authentic items) and, optionally, with the confidence score.

FIG. 3 depicts a procedure 300 in an example implementation of authenticating items using a learning model. The procedure 300 may implement, or be implemented by, aspects of FIGS. 1 and 2. For example, the procedure 300 may be implemented by an item authentication system, an image capture system, and/or a computing device, such as the item authentication system 104, the image capture system 106, and the computing device 102 as described with reference to FIGS. 1 and 2.

At 302, an item is received. For example, an image capture system (e.g., an image capture system 106 as described with reference to FIG. 1) can receive an item. The item can include an item that is to be listed for sale and/or an item that is being processed for distribution to an intended recipient. For example, the item can include a physical good, including, but not limited to, apparel, an electronic component of a device, an electronic device, a household appliance, a component of a mechanical device, a mechanical device, or any other physical good.

At 304, receipt of the item is confirmed. For example, the image capture system can indicate to an item authentication system and/or a computing device that the item is received.

At 306, images of the item are obtained. The image capture system can capture one or more images of the item, including images of the item captured from different angles. The images can include macroscopic images (e.g., in addition to, or as an alternative to microscopic images), such that the images include an entirety of the item from the different angles. For example, the images can include still photographs including a front view of the item, a back view of the item, a top view of the item, a bottom view of the item, and one or more side views of the item, among other examples. In some other examples, the images can include a video that includes the item from different angles.

At 308, authentication of the item is performed. An item authentication system can obtain the images from the image capture system and can provide the images, among other data, as input to one or more learning models, as described with reference to FIGS. 1 and 2. The learning models can output a binary value (e.g., a prediction, a classification) that indicates whether the item is counterfeit or authentic, as well as a confidence score that indicates a certainty or likelihood that the binary value is correct or accurate. The item authentication system can evaluate the confidence score to determine whether to verify the binary value. In some examples, by using microscopic images 202 of the item, rather than microscopic level images, there are fewer images 202 of the item and authentication of the item does not include a relatively large amount of preprocessing of the images 202 (e.g., greater than a threshold amount of processing resources).

For example, at 310, the confidence score is compared to a first threshold value to determine whether a third tier (e.g., tier 3) is satisfied. The item authentication system can compare the confidence score to a defined first threshold value (e.g., a default threshold value or a user-specified threshold value), and if the confidence score satisfies the first threshold value, then the item falls into or satisfies a third tier. The confidence score can satisfy the first threshold value if the confidence score is less than the first threshold value (e.g., a likelihood that the binary value is correct is less than a threshold value). The confidence score can fail to satisfy the first threshold value if the confidence score is greater than the first threshold value (e.g., a likelihood that the binary value is correct is greater than a threshold value).

If the confidence score fails to satisfy the first threshold value, then at 312, the confidence score is compared to a second threshold value to determine whether a second tier (e.g., tier 2) is satisfied. The item authentication system can compare the confidence score to a defined second threshold value (e.g., a default threshold value or a user-specified threshold value), and if the confidence score satisfies the second threshold value, then the item falls into or satisfies a second tier. The confidence score can satisfy the second threshold value if the confidence score is less than the first threshold value and less than the second threshold value (e.g., a likelihood that the binary value is correct is less than a first threshold value and a second threshold value). The confidence score can fail to satisfy the second threshold value if the confidence score is greater than the first threshold value and the second threshold value (e.g., a likelihood that the binary value is correct is greater than the first threshold value and the second threshold value).

If the confidence score fails to satisfy the second threshold value, then at 314, the confidence score is compared to a third threshold value to determine whether a first tier (e.g., tier 1) is satisfied. The item authentication system can compare the confidence score to a defined third threshold value (e.g., a default threshold value or a user-specified threshold value), and if the confidence score satisfies the third threshold value, then the item falls into or satisfies a first tier. The confidence score can satisfy the third threshold value if the confidence score is less than the first threshold value, less than the second threshold value, and less than the third threshold value (e.g., a likelihood that the binary value is correct is less than a first threshold value, a second threshold value, and a third threshold value).

If the confidence score satisfies a third tier, then at 316, a full authentication verification is performed. For example, a human can manually perform an authentication verification process by analyzing the item to determine whether the binary value indicating the authenticity of the item is correct. The authentication verification process can include a series of comparisons of different aspects or attributes of the item to an original item, such that if the aspects or attributes of the item match the original item, then the item is verified as authentic. If one or more of the aspects or attributes of the item fail to match the original item, then the item is determined to be counterfeit. The aspects or attributes can include, but are not limited to, a material of the item, a color of the item, one or more markings on the item, and/or one or more patterns of the item, among other examples.

If the confidence score satisfies a second tier, then at 318, a partial authentication verification is performed. For example, a human can manually perform at least a portion of an authentication verification process, including comparing one or more aspects of an item to an original item. If the aspects of the item match the original item, then the item is verified as authentic. If one or more of the aspects of the item fail to match the original item, then the item is determined to be counterfeit.

In some examples, for a partial authentication verification and/or for a full authentication verification, a computing device can display a control via a user interface. The control can be selectable to indicate a true authenticity of the item. For example, the control can include a button, text field, or any other selectable element. The computing device can receive user input via the control that indicates the true authenticity of the item (e.g., authentic or counterfeit).

If the confidence score satisfies a first tier and the binary value indicates that the item is authentic, if the full authentication verification results in the item being verified as authentic, and/or if the partial authentication verification results in the item being verified as authentic, then, at 320, the item is processed for shipping (e.g., distribution). If the confidence score satisfies the first tier and the binary value indicates that the item is counterfeit, if the full authentication verification results in the item being verified as counterfeit, and/or if the partial authentication verification results in the item being verified as counterfeit, then the item authentication system can cancel one or more data transactions related to processing the item for shipping and/or related to a sale of the item. For example, the data transactions can include a data transaction between a merchant and a payment platform to cause exchange of payment for the item, a data transaction between a shipping service and an online marketplace application to cause distribution of an item to an intended recipient, or any other data transactions related to a sale and/or distribution of the item.

In some examples, at 322, the learning models can be updated (e.g., retrained) using authentication verification results 324. The authentication verification results 324 can be obtained from the full authentication verification and/or the partial authentication verification, such as via the control displayed at the user interface of the computing device. The item authentication system can use the authentication verification results 324, as well as one or more images or image segments of the item (e.g., the images obtained at 306), to update learning models by fine-tuning the learning models according to a supervised approach, as described with reference to FIG. 1. The item authentication system can use the updated learning models to perform authentication of additional items.

Although three tiers are illustrated, there may be any numerical quantity of tiers and/or threshold comparisons. In some examples, the learning models may generate confidence scores that consistently satisfy the third threshold value (e.g., all of the confidence scores for a set of items satisfy the third threshold value). For example, the item authentication system may continue to update the parameters of the learning models until the accuracy and/or precision of the learning models and the corresponding confidence scores generated by the learning models are greater than respective threshold values. If the confidence scores are consistently satisfying the third threshold value, then the item authentication system can automatically perform authentication for the items (e.g., without user input or manual authentication verification), such as by eliminating the comparison of the confidence score to the first threshold and the second threshold, as well as the full authentication verification and partial authentication verification procedures.

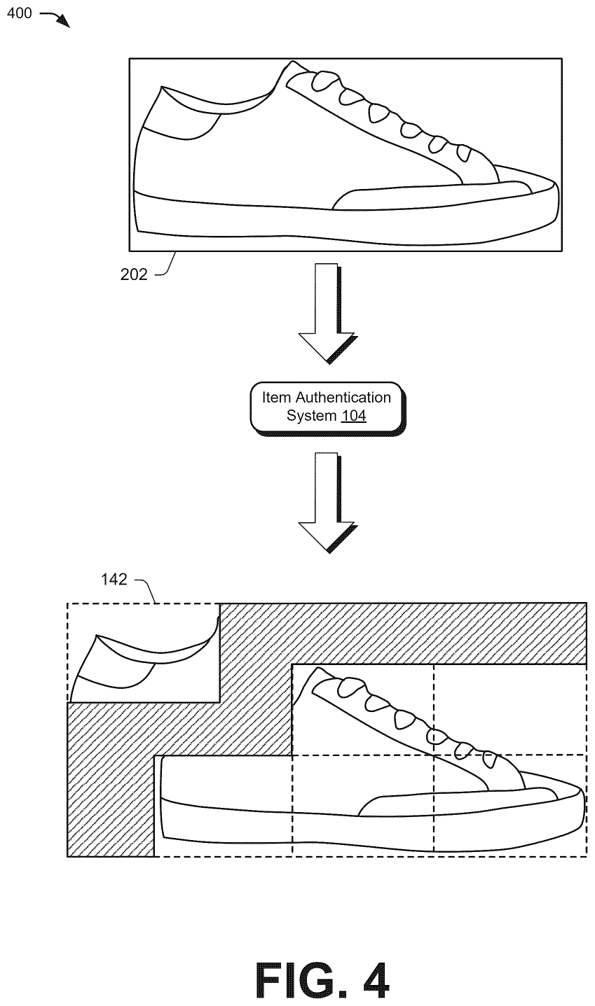

FIG. 4 depicts an example 400 of image segmentation for authenticating items using a learning model. The example 400 may implement, or be implemented by, aspects of FIGS. 1 through 3. For example, the example 400 can be implemented an item authentication system 104, such as the item authentication system 104 as described with reference to FIG. 1.

An item authentication system 104 can obtain an image 202 (e.g., an image 202 as described with reference to FIG. 2). For example, the item authentication system 104 can receive the image from an image capture system and/or can obtain the image 202 from a data storage accessible by the item authentication system 104 and the image capture system. The item authentication system 104 can include image segmentation logic configured to cause the item authentication system 104 to divide the image 202 into multiple image segments 142. The image segments 142 can additionally, or alternatively, be referred to as segments or tiles. The image 202 can be divided into any numerical quantity of image segments 142 (e.g., 2×3, 3×3, or any other numerical quantity of image segments 142). For example, the example 400 includes six image segments 142.

An image segment 142 can include a portion of an item represented by the image 202. For example, if the image 202 is a side view of a shoe, then an image segment 142 can include a portion of the heel of the shoe, a portion of the laces of the shoe, and/or a portion of the body of the shoe, among other examples. The item authentication system 104 can analyze the image 202 to determine a numerical quantity of image segments 142 for the image 202. The item authentication system 104 can determine a view of the item in the image 202, a level of detail in the image 202, a size of the image 202, or any other features related to the item in the image 202 or the image 202. For example, the item authentication system 104 can implement one or more image processing techniques, such as by using a learning model to identify different characteristics of the image 202 and/or by performing other image processing and object identification techniques.

The item authentication system 104 can determine to divide the image 202 into a relatively large numerical quantity of image segments if a relatively large portion of the item is displayed in the image 202 based on the view of the item in the image 202 (e.g., greater than a threshold percentage of the item is displayed in the image). Additionally, or alternatively, the item authentication system 104 can determine to divide the image 202 into a relatively small numerical quantity of image segments if a relatively small portion of the item is displayed in the image 202 based on the view of the item in the image 202 (e.g., less than a threshold percentage of the item is displayed in the image). The item authentication system 104 can determine to divide the image 202 into a relatively large numerical quantity of image segments if a level of detail in the image 202 is relatively high or a size of the image is relatively large (e.g., greater than a threshold level of detail or size). Additionally, or alternatively, the item authentication system 104 can determine to divide the image 202 into a relatively small numerical quantity of image segments if a level of detail in the image 202 is relatively low or a size of the image is relatively small (e.g., less than a threshold level of detail or size).

In some examples, the item authentication system 104 can provide the image segments 142 as input to a learning model, and the learning model can determine one or more of the segments (e.g., a portion of the image segments 142 and/or all of the image segments 142) to use to determine an authenticity of the item. For example, if a shoe can be determined as counterfeit or authentic using a tread of the shoe, then then image segments 142 that include the tread can be provided as input to a learning model that determines authenticity of the item, while image segments 142 that do not include the tread can be discarded or otherwise ignored by the learning model that determines authenticity of the item. Thus, a first learning model can receive the image segments 142 as input and can output a portion of the image segments 142 that are relevant for obtaining an authenticity of the item. The item authentication system 104 can provide the portion of the image segments 142 as input to a second learning model, which provides a binary value indicating the authenticity of the item and/or a confidence score as output. Additionally, or alternatively, the item authentication system 104 can use a single learning model to determine the portion of the image segments 142 and to provide the binary value indicating the authenticity of the item and/or the confidence score. By analyzing a portion of the image segments 142, the learning model can reduce an amount of processing and memory resources used to obtain the binary value indicating the authenticity of the item and/or the confidence score (e.g., because the leaning model does not analyze the discarded image segments 142).

Although the image segments 142 are illustrated as being generated by the item authentication system 104 (e.g., using image segmentation logic and/or by a learning model manager), the image segments 142 may additionally, or alternatively, be generated by the image capture system 106, or any other device in communication with the item authentication system 104. Further, although the image is illustrated as being representative of a shoe, the item in the image may be any item.

FIG. 5 depicts an example of a machine learning environment 500 for authenticating an item using images of the item. The machine learning environment 500 may implement, or be implemented by, aspects of FIGS. 1 through 4. For example, the machine learning environment 500 can be implemented an item authentication system 104, such as the item authentication system 104 as described with reference to FIG. 1.

In some examples, the item authentication system can provide one or more images (e.g., the image 202-a through the image 202-d) as input to one or more trained learning models. In some examples, the item authentication system can divide the respective images into image segments prior to providing the images as input to the trained learning models. In some other examples, a learning model of the trained learning models can divide the image into segments and/or select segments that are relevant for determining an authenticity of an item in the images.

In some examples, a feature extraction component 502 of at least one of the trained learning models can generate image embeddings for the respective images. An image embedding is a vector, referred to as a feature vector, with a defined length that represents an image (e.g., an array of shape 1×768). The image embedding captures one or more features or attributes in the image, such as edges, color, and patterns in the image. In some examples, the feature extraction component 502 may be an example of a neural network, such as a convolutional neural network (CNN), that encodes images into compact and informative vectors (e.g., the image embeddings). For example, the feature extraction component 502 can generate an image embedding 504-a of the image 202-a, an image embedding 504-b of the image 202-b, an image embedding 504-c of the image 202-c, and an image embedding 504-d of the image 202-d.

The image embeddings of the different images of an item can be combined to form a joint embedding 506 representative of the different views of the item. The join embedding can be an array or vector representative of the item (e.g., an array of shape 1×3072). For example, the image embedding 504-a through the image embedding 504-d can be combined to form a joint embedding 506. The joint embedding 506 can be provided as input to a classifier component 508 of at least one trained learning model. The classifier component 508 can include a single classification layer (e.g., a linear classifier layer, a tree layer, or any other classification layers) that generates a prediction of whether the item is authentic or counterfeit, as well as a confidence score for the prediction. For example, the classifier component 508 can generate an authenticity prediction 510 that includes a binary value (e.g., authentic or counterfeit) and the confidence score. An item authentication system can use the authenticity prediction 510 to determine whether to process one or more data transactions (e.g., if the item is determined to be authentic) or to cancel one or more data transactions (e.g., if the item is determined to be counterfeit), as described with reference to FIGS. 1 through 3.

Having discussed exemplary details of determining authenticity of an item using learning models, consider now some examples of procedures to illustrate additional aspects of the techniques.

### Example Procedures

This section describes examples of procedures for authenticating items using a learning model. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

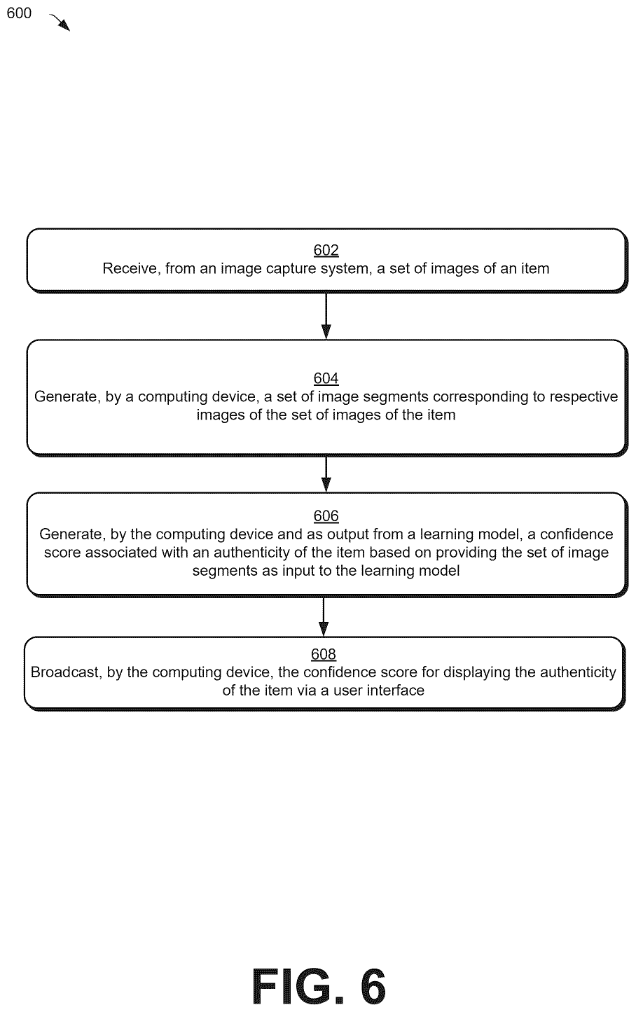

FIG. 6 depicts a procedure 600 in an example implementation of authenticating items using a learning model.

At 602, a set of images of an item is received from an image capture system. For example, the image capture system can obtain images of the item from different angles or views. The image capture system can transmit the images to an item authentication system implemented, at least in part, by a computing device. The images can include any numerical quantity of images and can include macroscopic images of the item (e.g., including the entire item in the image, rather than microscopic portions of the item).

At 604, a set of image segments corresponding to respective images of the set of images of the item are generated by the computing device. In some examples, an item authentication system implemented by the computing device can generate the set of image segments by dividing respective images into a numerical quantity of image segments. The numerical quantity of image segments can depend on different attributes and/or features of the image, such as a size of the image, a quality (e.g., level of detail) of the image, and a view of the item in the image, among other attributes and/or features.

At 606, a confidence score associated with an authenticity of the item is generated by the computing device and as output from a learning model based on providing the set of image segments as input to the learning model. The confidence score can indicate a likelihood (e.g., a certainty, a probability) that the item is authentic or counterfeit. The confidence score can be in the form of a percentage (e.g., out of 100%), or any other numerical value.

In some examples, the learning model includes a feature component and a classifier component. The computing device receives one or more feature vectors representative of one or more image segments as output from the feature component of the learning model by providing the image segments as input to the feature component of the learning model. The computing device receives the confidence score as output from the classifier component of the learning model by providing the feature vectors as input to the classifier component of the learning model. The classifier component can include a linear classifier, a tree, and/or any other example classifier that is trained to output a binary value that indicates whether the item is authentic or counterfeit and the confidence score.

For example, the computing device obtains training data that includes images and/or image segments of respective items for input to the learning model and an authenticity of the respective items. The computing device can train the classifier component of the learning model to determine the confidence score by minimizing a loss function using the training data. In some cases, the one or more feature vectors represent attributes of the image segments, including one or more colors, edges, patterns, and/or features included in the image segments. In some examples, the computing device selects the one or more image segments using a learning model (e.g., by providing the set of image segments as input to the learning model), where the feature vectors are representative of the selected image segments.

At 608, the confidence score is broadcast for displaying the authenticity of the item via a user interface. For example, the computing device or another computing device can display one or more fields via the user interface and/or a graphical representation that includes respective confidence scores for one or more different items. In some cases, the computing device can broadcast (e.g., transmit, send) the confidence score to another device for display. Additionally, or alternatively, the computing device can broadcast the binary value (e.g., without the confidence score), such that the computing device indicates whether the item is counterfeit or authentic.

In some examples, if the confidence score fails to satisfy a threshold value, then the computing device receives an indication of the authenticity of the item via at least one control of the user interface and retrains the classifier component of the learning model to determine the confidence score by minimizing the loss function using the images of the item and the indication of the authenticity of the item. Thus, the computing device can continuously train the learning model to maintain a current, customized learning model for generating the confidence score that indicates the likelihood an item is authentic or counterfeit. For example, the computing device or another computing device can output a control for display via the user interface. The control is selectable to indicate a first value (e.g., authentic) or a second value (e.g., counterfeit) that is a true authenticity of the item when the confidence score fails to satisfy a threshold value.

In some variations, if the confidence score satisfies a threshold value, then the computing device processes a data transaction related to the item. Additionally, or alternatively, if the computing device receives an indication of a selection of the first value via the control, then the computing device processes a data transaction related to the item. In some other variations, if the computing device receives an indication of a selection of the second value via the control, then the computing device cancels processing of a data transaction related to the item.

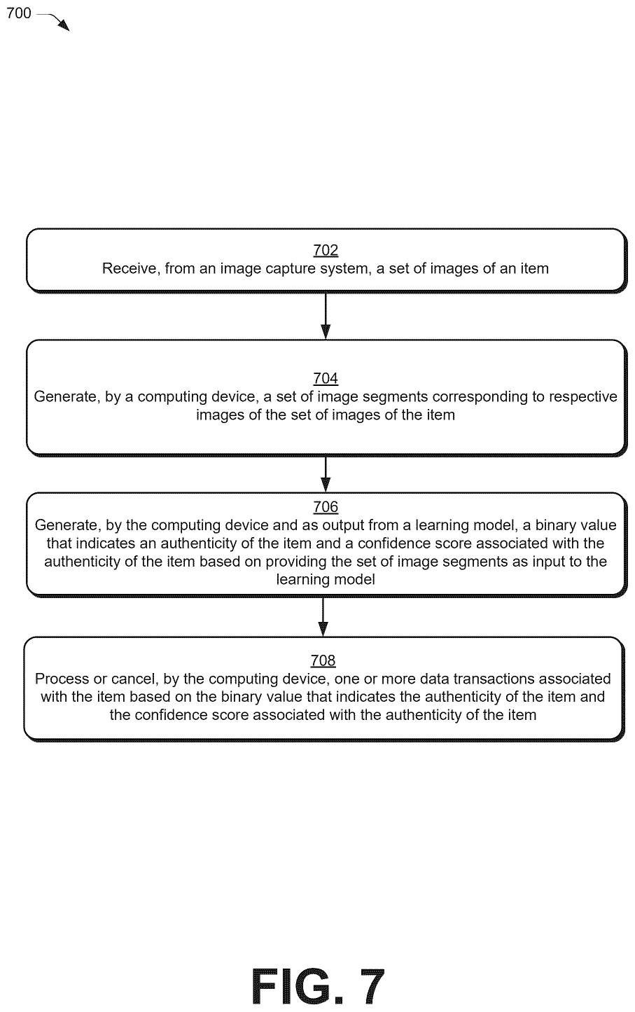

FIG. 7 depicts a procedure 700 in an example implementation of authenticating items using a learning model.

At 702, a set of images of an item is received from an image capture system. For example, the image capture system can obtain images of the item from different angles or views. The image capture system can transmit the images to an item authentication system implemented, at least in part, by a computing device. The images can include any numerical quantity of images and can include macroscopic images of the item (e.g., including the entire item in the image, rather than microscopic portions of the item).

At 704, a set of image segments corresponding to respective images of the set of images of the item are generated by the computing device. In some examples, an item authentication system implemented by the computing device can generate the set of image segments by dividing respective images into a numerical quantity of image segments. The numerical quantity of image segments can depend on different attributes and/or features of the image, such as a size of the image, a quality (e.g., level of detail) of the image, and a view of the item in the image, among other attributes and/or features.

At 706, a binary value that indicates an authenticity of the item and a confidence score associated with the authenticity of the item is generated by the computing device and as output from a learning model based on providing the set of image segments as input to the learning model. The confidence score can indicate a likelihood (e.g., a certainty, a probability) that the item is authentic or counterfeit. The confidence score can be in the form of a percentage (e.g., out of 100%), or any other numerical value. The binary output can include a first value that indicates the item is authentic or a second value that indicates the item is counterfeit.

In some examples, the learning model includes a feature component and a classifier component. The computing device receives one or more feature vectors representative of one or more image segments as output from the feature component of the learning model by providing the image segments as input to the feature component of the learning model. The computing device receives the binary value and the confidence score as output from the classifier component of the learning model by providing the feature vectors as input to the classifier component of the learning model. The classifier component can include a linear classifier, a tree, and/or any other example classifier that is trained to output the binary value and the confidence score.

For example, the computing device obtains training data that includes images and/or image segments of respective items for input to the learning model and an authenticity of the respective items. The computing device can train the classifier component of the learning model to determine the confidence score by minimizing a loss function using the training data. In some cases, the one or more feature vectors represent attributes of the image segments, including one or more colors, edges, patterns, and/or features included in the image segments. In some examples, the computing device selects the one or more image segments using a learning model (e.g., by providing the set of image segments as input to the learning model), where the feature vectors are representative of the selected image segments.

At 708, one or more data transactions are processed or canceled by the computing device based on the binary value that indicates the authenticity of the item and the confidence score associated with the authenticity of the item.

For example, the computing device can process the one or more data transactions if the binary value indicates that the item is authentic and if the confidence score satisfies one or more threshold values (e.g., a first tier, as described with reference to FIG. 3). In some other examples, the computing device can cancel the one or more data transactions if the binary value indicates that the item is counterfeit and the confidence score satisfies one or more threshold values.

In some cases, the computing device can determine the confidence score fails to satisfy at least one threshold value. The computing device or another computing device can output a control for display via a user interface if the confidence score fails to satisfy the threshold value. The control is selectable to indicate a true authenticity of the item. The computing device can receive an indication of a selection via the control. In some cases, the computing device processes the one or more data transactions if the selection indicates that the true authenticity of the item is authentic. In some other cases, the computing device cancels the one or more data transactions if the selection indicates that the true authenticity of the item is counterfeit. In some examples, the computing device can update and/or retrain the learning model using the selection as a labeled training data point and the image segments as an input training data point.

The one or more data transactions can include data transactions for a distribution of the item and/or data transactions for a sale of the item. In some cases, if the item is verified as authentic, the computing device can generate a listing for sale of the item and/or can process a payment and distribution information for the item. The listing for sale of the item can include populating one or more fields of the listing with the binary value that indicates the item is authentic and/or the confidence score. In some other cases, if the item is verified as counterfeit, the computing device can cancel or suspend listing the item for sale, cancel or suspend payment for the item, and/or can cancel or suspend processing information for distribution of the item.

Having described examples of procedures in accordance with one or more implementations, consider now an example of a system and device that can be utilized to implement the various techniques described herein.

### Example System and Device

FIG. 8 illustrates an example of a system generally at 800 that includes an example of a computing device 802 that is representative of one or more computing systems and/or devices that may implement the various techniques described herein. This is illustrated through inclusion of the application 110 and the item authentication system 104. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interfaces 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that may be configured as processors, functional blocks, and so forth. This may include implementation in hardware as an application specific integrated circuit or other logic device formed using one or more semiconductors. The hardware elements 810 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically executable instructions.

The computer-readable media 806 is illustrated as including memory/storage 812. The memory/storage 812 represents memory/storage capacity associated with one or more computer-readable media. The memory/storage 812 may include volatile media (such as random-access memory (RAM)) and/or nonvolatile media (such as read only memory (ROM), Flash memory, optical disks, magnetic disks, and so forth). The memory/storage 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive, or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 may include applications and/or data that can be utilized while computer processing is executed on servers that are remote from the computing device 802. Resources 818 can also include services provided over the Internet and/or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving, from an image capture system, a plurality of images of an item;
generating, by a computing device, a plurality of image segments corresponding to respective images of the plurality of images of the item;
generating, by the computing device and as output from a learning model, a confidence score associated with an authenticity of the item based on providing the plurality of image segments as input to the learning model; and
broadcasting, by the computing device, the confidence score for displaying the authenticity of the item via a user interface.

2. The computer-implemented method of claim 1, wherein the learning model includes a feature component and a classifier component, and wherein generating the confidence score comprises:
receiving, as output from the feature component of the learning model, one or more feature vectors representative of one or more image segments of the plurality of image segments based on providing the plurality of image segments as input to the feature component of the learning model; and
receiving, as output from the classifier component of the learning model, the confidence score based on providing the one or more feature vectors as input to the classifier component of the learning model.

3. The computer-implemented method of claim 2, wherein the one or more feature vectors are associated with attributes of the plurality of image segments.

4. The computer-implemented method of claim 2, further comprising:
obtaining training data that includes a plurality of images of respective items for input to the learning model and an authenticity of the respective items; and
training, by minimizing a loss function using the training data, the classifier component of the learning model to determine the confidence score.

5. The computer-implemented method of claim 4, wherein the confidence score fails to satisfy a threshold value, the computer-implemented method further comprising:
receiving, via at least one control of the user interface, an indication of the authenticity of the item; and
retraining, by minimizing the loss function using the plurality of images of the item and the indication of the authenticity of the item, the classifier component of the learning model to determine the confidence score.

6. The computer-implemented method of claim 2, wherein receiving the one or more feature vectors comprises selecting, by the computing device and based at least in part on providing the plurality of image segments as input to the learning model, the one or more image segments of the plurality of image segments.

7. The computer-implemented method of claim 1, further comprising processing a data transaction associated with the item based on the confidence score satisfying a threshold value.

8. The computer-implemented method of claim 1, further comprising causing display of a control at the user interface, wherein the control is selectable to indicate a first value or a second value associated with a true authenticity of the item based on the confidence score failing to satisfy a threshold value.

9. The computer-implemented method of claim 8, further comprising:
receiving a selection of the first value via the control; and
processing a data transaction associated with the item based on the selection.

10. The computer-implemented method of claim 8, further comprising:
receiving a selection of the second value via the control; and
canceling processing of a data transaction associated with the item based on the selection.

11. A system comprising:
one or more processors; and
a computer-readable storage medium storing instructions that are executable by the one or more processors to perform operations comprising:
receiving, from an image capture system, a plurality of images of an item;
generating, by a computing device, a plurality of image segments corresponding to respective images of the plurality of images of the item;
generating, by the computing device and as output from a learning model, a confidence score associated with an authenticity of the item based on providing the plurality of image segments as input to the learning model; and
broadcasting, by the computing device, the confidence score for displaying the authenticity of the item via a user interface.

12. A computer-implemented method comprising:
receiving, from an image capture system, a plurality of images of an item;
generating, by a computing device, a plurality of image segments corresponding to respective images of the plurality of images of the item;
generating, by the computing device and as output from a learning model, a binary value that indicates an authenticity of the item and a confidence score associated with the authenticity of the item based on providing the plurality of image segments as input to the learning model; and
processing or canceling, by the computing device, one or more data transactions associated with the item based on the binary value that indicates the authenticity of the item and the confidence score associated with the authenticity of the item.

13. The computer-implemented method of claim 12, wherein processing or canceling the one or more data transactions associated with the item comprises processing the one or more data transactions based on the binary value that indicates the authenticity of the item indicating that the item is authentic and based on the confidence score satisfying one or more threshold values.

14. The computer-implemented method of claim 12, wherein processing or canceling the one or more data transactions associated with the item comprises canceling the one or more data transactions based on the binary value that indicates the authenticity of the item indicating that the item is counterfeit and based on the confidence score satisfying one or more threshold values.

15. The computer-implemented method of claim 12, further comprising:
determining the confidence score fails to satisfy at least one threshold value;
causing display of a control at a user interface, wherein the control is selectable to indicate a true authenticity of the item based on the confidence score failing to satisfy the at least one threshold value; and
receiving a selection via the control.

16. The computer-implemented method of claim 15, wherein processing or canceling the one or more data transactions associated with the item comprises processing the one or more data transactions based on the selection indicating that the true authenticity of the item is authentic.

17. The computer-implemented method of claim 15, wherein processing or canceling the one or more data transactions associated with the item comprises canceling the one or more data transactions based on the selection indicating that the true authenticity of the item is counterfeit.

18. The computer-implemented method of claim 15, further comprising retraining the learning model based on the selection and the plurality of image segments.

19. The computer-implemented method of claim 12, wherein the one or more data transactions are associated with one or more of a distribution of the item or a sale of the item.

20. The computer-implemented method of claim 12, wherein the learning model includes a feature component and a classifier component, and wherein generating the binary value that indicates the authenticity of the item and the confidence score associated with the authenticity of the item comprises:
receiving, as output from the feature component of the learning model, one or more feature vectors representative of one or more image segments of the plurality of image segments based on providing the plurality of image segments as input to the feature component of the learning model; and
receiving, as output from the classifier component of the learning model, the binary value that indicates the authenticity of the item and the confidence score associated with the authenticity of the item based on providing the one or more feature vectors as input to the classifier component of the learning model.
